(19) United States
(12) Patent Application Publication
(10) Pub. No.: US 2011/0016722 A1
(43) Pub. Date: Jan. 27, 2011

(54) RAZOR SYSTEM

(76) Inventor: Dayton Stark, Houston, TX (US)

Correspondence Address: ITALIA IP, 3500 WEST OLIVE AVE., SUITE 300, BURBANK, CA, 91505, US

(21) Appl. No.: 12/510,189

(22) Filed: Jul. 27, 2009

(51) Int. Cl. B26B 19/28; B26B 19/38

(52) U.S. Cl. 30/45; 30/50

(57) ABSTRACT

A razor system includes a cage having a plurality of arcuate members, wherein the arcuate members are separated by adjacent openings, each opening operable to receive hair for trimming. The system also includes one or more blade coupled to a rotatable shaft. The rotatable shaft extends into the cage and is operable to rotate the blades within the cage so that hair entering the cage via the cage openings may be trimmed by the blades.

### BACKGROUND OF INVENTION

This application relates generally to hair trimming or shaving devices and more particularly to an improved razor system.

### SUMMARY

Shaving, or otherwise trimming hair, frequently involves approaching hair from a variety of awkward angles and passing a razor, or other hair cutting implement, over an uneven skin surface. Thus, shaving, or otherwise trimming hair, can often lead to nicks, cuts and scratches on one's skin. Therefore, it would be beneficial to have the capability to easily approach the hair from a variety of angles, trim hair protruding from a variety of uneven surfaces, while also protecting the skin against nicks, cuts and/or scratches.

In particular, this application discloses a razor system comprising a cage comprising a plurality of arcuate members, wherein the arcuate members are separated by adjacent openings, each opening operable to receive hair for trimming; a rotatable shaft extending into the cage; and one or more blades coupled to the rotatable shaft, each blade operable to trim hair received by each opening of the cage.

This application also discloses a method for trimming hair comprising: rotating at lease one blade within a cage, wherein the cage comprises a plurality of arcuate members, wherein the arcuate members are separated by adjacent openings, each opening operable to receive hair for trimming; and placing the cage against hair for trimming, wherein at least a portion of hair enters at least one opening to be trimmed by the blade.

This application further discloses a razor system comprising: a substantially spherical cage comprising a plurality of arcuate members, wherein the arcuate members are separated by adjacent openings, each opening operable to receive hair for trimming; a rotatable shaft extending into the cage; one or more blades coupled to the rotatable shaft, each blade operable to trim hair received by each opening of the cage; and a motor for rotating the rotatable shaft.

### BRIEF DESCRIPTION OF THE DRAWINGS

The drawings, when considered in connection with the following description, are presented for the purpose of facilitating an understanding of the subject matter sought to be protected.

FIG. 1 is a perspective view of a razor system;

FIG. 2 is a cut-away view of a portion of the razor system of FIG. 1;

FIG. 3 is a schematic view of a arcuate member and a blade; and

FIG. 4 is a schematic view of an alternative arcuate member and alternative blade.

### DETAILED DESCRIPTION

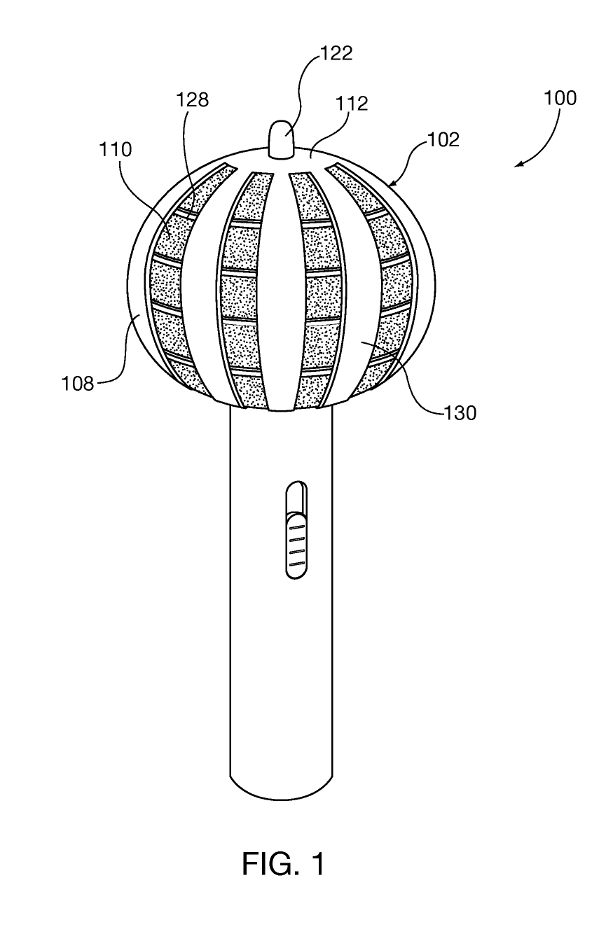

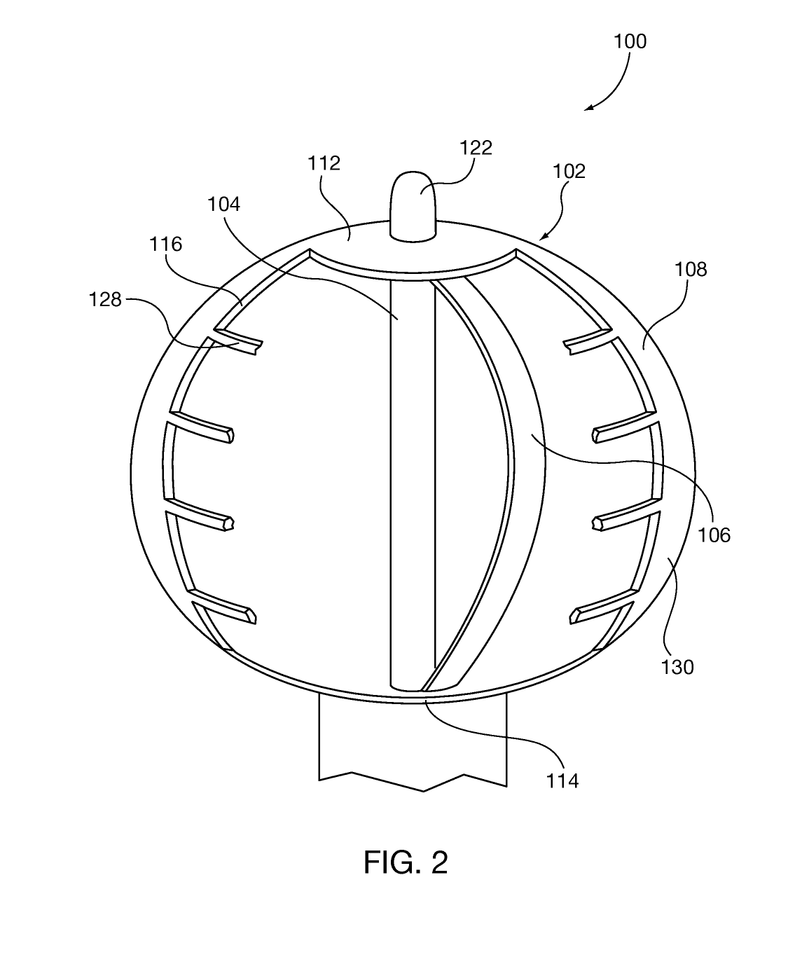

Referring now to FIGS. 1-2, a razor system 100 is shown. The razor system 100 generally includes a cage 102, a rotatable shaft 104, and one or more blades 106 coupled to the rotatable shaft 104. The cage 102 comprises a plurality of arcuate members 108, wherein the arcuate members 108 are separated by adjacent openings 110. The openings 110 are configured to receive hair to be trimmed by the one or more blades 106. The arcuate members 108 may be coupled to, or otherwise be integral with, a top portion 112 of the cage 102 and extend towards and be coupled to, or otherwise be integral with, a bottom portion 114 of the cage 102. In one embodiment, one or more edges 116 of each arcuate member 108 may be a beveled and/or sharpened edge to also provide each member 108 the capability of trimming or assisting in the trimming of hair. The arcuate members 108 may be arranged to provide the cage 102 with a generally spherical shape. However, it will be appreciated that the cage 102 may comprise any suitably shaped members 108 that may provide the cage 102 with any suitable shape, including, but not limited to, an ellipsoid, a pear shape, cube, pyramid, cone, or any other suitable shape. Also, as shown in FIGS. 1-3, each arcuate member 108 may be a relatively smooth and continuous piece. In an alternative embodiment, as best shown in FIG. 4, each arcuate member 108 may be formed from a plurality of generally planar member 118 with each planar member 118 coupled to at least one other adjacent planar member 118 whereby the planar members 118 are arranged relative to one another to provide an overall and generally arcuate shape to the arcuate member 108.

The rotatable shaft 104 extends from a handle or casing 120 into the cage 102. The distal end 122 of the shaft 104 may be rotatably coupled to the top portion 112 of the cage 102. As will be discussed further below, the shaft 104 is operable to rotate relative to the cage 102 and provide a hair cutting motion to the blade(s) 106 coupled thereto. The shaft 104 may be rotated by any suitable means, including, but not limited to, manually, via an electric motor, etc. In one embodiment, the shaft 104 is rotated by an electric motor that is encased, along with one or more batteries, in the casing 120.

One or more blades 106 is coupled to the shaft 104. The blade(s) 106 may be coupled to the shaft by any suitable means, including, but not limited to, mechanical fasteners, adhesive, bonding, welding, etc. In one embodiment, at least one edge 124 of each blade 106 is beveled and/or sharpened such that the blade 106 may cut hair. Also, in one embodiment, one or more blades 106 may be arcuate in shape. As shown in FIGS. 1-3, each blade 106 may be formed as a relatively smooth and continuous piece. In an alternative embodiment, as shown in FIG. 4, each blade may be formed from a plurality of generally planar member 126 with each planar member 126 coupled to at least one other adjacent planar member 126 whereby the planar members 126 are arranged relative to one another to provide an overall and generally arcuate shape to the blade 106.

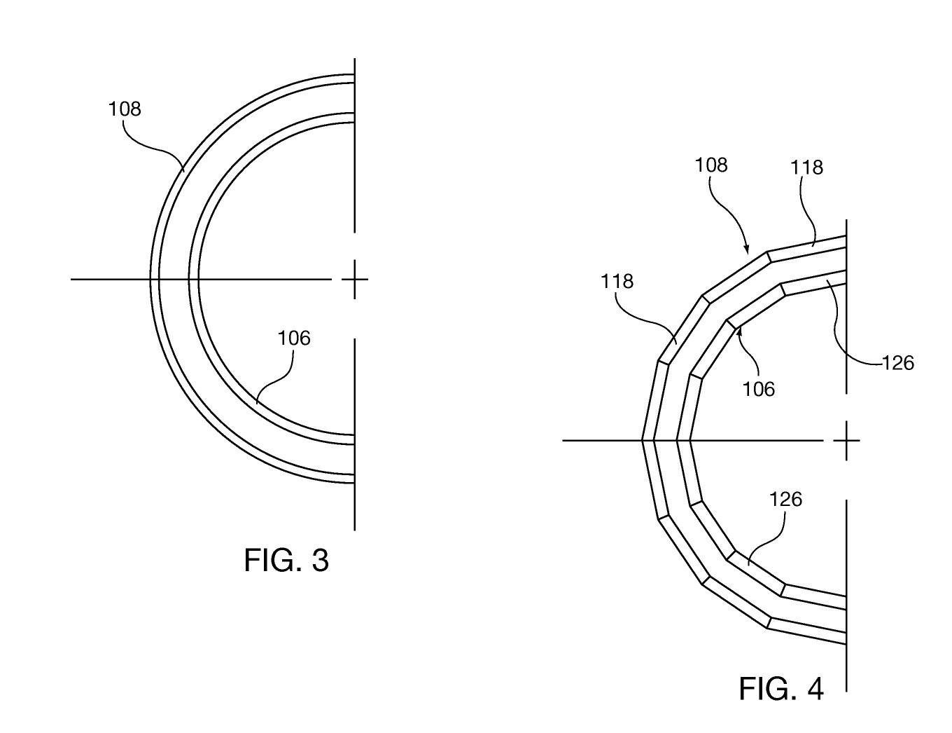

Also, as shown in FIGS. 3-4, the radius of curvature of at least one blade 106 may be substantially similar to the radius of curvature of at least one arcuate member 108 so that the blade 106 is substantially parallel with the corresponding arcuate member 108 along all points thereof. While the illustrative embodiment shows the blades 106 as being arcuate in shape, it will be appreciated that the blade(s) may have any suitable shape and remain within the scope of the present disclosure. Additionally, while the radius of curvature of one or more blades 106 is shown as substantially similar to the radius of curvature of one or more cage arcuate members 108, it will be appreciated that one or more blades 106 may have any suitable relationship relative to one or more arcuate members 108 and remain within the scope of the present disclosure.

The system 100 may optionally include one or more guard bars 128 that intersect, or are otherwise coupled to, one or more cage arcuate members 108 such that the guard bars 128 extend between one or more openings 110 so as to limit the size of objects that may pass through the opening(s) 110 into the interior chamber of the cage 102. The guard bars 128 may extend between the edges 116 of adjacent arcuate members 108. Alternatively, the guard bars 128 may overlay the exterior surface 130 of one or more arcuate members 108. In one non-limiting example, the guard bars 128 may be rings that are placed about the cage 102 and engage the outer surfaces 130 of one or more arcuate members 108. The guard bars 128 may be integral with one or more arcuate members 108. Alternatively, one or more guard bars 128 may be coupled to one or more arcuate members via any suitable means, including, but not limited to, mechanical fasteners, welding, adhesive, bonding, etc.

In operation, the cage 102 is placed against skin so that at least a portion of hair protruding from the skin may enter into the cage 102 via the openings 110. The blades 106 are rotated within the cage 102 by rotation of the shaft 104. As the blades 106 rotate, the blades 106 cut the hair that has extended into the cage via the opening(s) 110. Advantageously, a cage 102 comprising arcuately shaped members 108 permits a user to trim hair from a variety of different angles and similarly configured blades 106 may further assist the efficiency such a shaped cage 102 may provide. Other geometrically shaped cages and/or blades may also provide similar advantages and efficiency.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A razor system comprising:
a cage comprising a plurality of arcuate members, wherein the arcuate members are separated by adjacent openings, each opening operable to receive hair for trimming;
a rotatable shaft extending into the cage; and
one or more blades coupled to the rotatable shaft, each blade operable to trim hair received by each opening of the cage.

2. The system of claim 1 wherein at least one blade is an arcuate blade.

3. The system of claim 2 wherein the radius of curvature of at least one arcuate blade is substantially similar to the radius of curvature of at least one arcuate member.

4. The system of claim 1 wherein each blade comprises a plurality of planar members, wherein each planar member is coupled to at least one adjacent planar member.

5. The system of claim 4 wherein the planar members are arranged so as to provide a generally arcuate shape to the blade.

6. The system of claim 1 wherein the arcuate members are arranged such that the cage has a substantially spherical shape.

7. The system of claim 1 further comprising one or more guard bars, wherein each of the guard bars is arranged to intersect at least one arcuate member.

8. The system of claim 1 wherein the arcuate members are arranged such that the case has a substantially ellipsoid shape.

9. The system of claim 1 further comprising an electric motor coupled to the rotatable shaft, the electric motor operable to rotate the rotatable shaft.

10. A method for trimming hair comprising:
rotating at lease one blade within a cage, wherein the cage comprises a plurality of arcuate members, wherein the arcuate members are separated by adjacent openings, each opening operable to receive hair for trimming; and
placing the cage against hair for trimming, wherein at least a portion of hair enters at least one opening to be trimmed by the blade.

11. The method of claim 10 wherein at least one blade is an arcuate blade.

12. The method of claim 11 wherein the radius of curvature of at least one arcuate blade is substantially similar to the radius of curvature of at least one arcuate member.

13. The method of claim 10 wherein the arcuate members are arranged such that the cage has a substantially spherical shape.

14. The method of claim 10 wherein the cage comprises one or more guard bars, wherein each of the guard bars is arranged to intersect at least one arcuate member.

15. The method of claim 10 wherein each of the guard bars is substantially circular in shape.

16. A razor system comprising:
a substantially spherical cage comprising a plurality of arcuate members, wherein the arcuate members are separated by adjacent openings, each opening operable to receive hair for trimming;
a rotatable shaft extending into the cage;
one or more blades coupled to the rotatable shaft, each blade operable to trim hair received by each opening of the cage; and
a motor for rotating the rotatable shaft.

17. The system of claim 16 wherein each cage arcuate member comprises at least one sharp beveled edge.

18. The system of claim 16 wherein at least one blade is an arcuate blade.

19. The system of claim 16 wherein the radius of curvature of at least one arcuate blade is substantially similar to the radius of curvature of at least one arcuate member.

20. The system of claim 16 further comprising one or more guard bars, wherein each of the guard bars is arranged to perpendicularly intersect each of the arcuate members.
